(19) United States
(12) Patent Application Publication
(10) Pub. No.: US 2008/0120092 A1
(43) Pub. Date: May 22, 2008

(54) Phrase pair extraction for statistical machine translation

(75) Inventors: Robert C. Moore, Mercer Island, WA (US); Luke S. Zettlemoyer, Cambridge, MA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/601,992

(22) Filed: Nov. 20, 2006

(51) Int. Cl. G06F 17/28

(52) U.S. Cl. 704/4

(57) ABSTRACT

In a machine translation system, possible phrase pairs are extracted from a word-aligned corpus for inclusion in a phrase translation table. Feature values associated with the phrase pairs are calculated and translation model parameters for use in a decoder are trained. The translation model parameters are then used to re-extract a subset of phrase pairs from the original set of extracted phrase pairs. The feature values associated with the subset of phrase pairs are recalculated, and the translation model parameters are re-optimized based on the newly extracted subset of phrase pairs and the feature values associated with those phrase pairs.

### BACKGROUND

Machine translation is a process by which a textual input in a first language (a source language) is automatically translated into a textual output in a second language (a target language). Some machine translation systems attempt to translate a textual input word for word, by translating individual words in the source text into individual words in the target language. However, this has led to translations that are not very fluent.

Therefore, some systems currently translate based on phrases. Machine translation systems that translate sequences of words in the source text, as a whole, into sequences of words in the target language, as a whole, are referred to as phrase based translation systems.

During training, these systems receive a word-aligned bilingual corpus, where words in a source training text are aligned with corresponding words in a target training text. Based on the word-aligned bilingual corpus, phrase pairs are extracted that are likely translations of one another. By way of example, using English as the source text and French as the target text, phrase based translation systems find a sequence of words in English for which a sequence of words in French is a translation of that English word sequence.

Phrase translation tables are important to these types of phrase-based statistical machine translation systems. The phrase translation tables provide pairs of phrases that are used to construct a large set of potential translations for each input sentence, along with feature values associated with each phrase pair. The feature values are used to select a best translation from a given set of potential translations.

For purposes of the present discussion, a “phrase” can be a single word or any contiguous sequence of words. It need not correspond to a complete linguistic constituent.

There are a variety of ways of building phrase translation tables. One current system for building phrase translation tables selects, from a word alignment provided for a parallel bilingual training corpus, all pairs of phrases (up to a given length) that meet two criteria. A selected phrase pair must contain at least one pair of words linked by the word alignment and must not contain any words that have word-alignment links to words outside the phrase pair.

If the word alignment of the training corpus includes many unaligned words, there is considerable uncertainty as to where the word sequences constituting phrase pairs begin and end. Therefore, this type of procedure typically generates many phrase pairs that result in translation candidates that are not even remotely reasonable.

The discussion above is merely provided for general background information and is not intended to be used as an aid in determining the scope of the claimed subject matter.

### SUMMARY

In a machine translation system, possible phrase pairs are extracted from a word-aligned training corpus. Feature values associated with the phrase pairs are calculated and parameters of a translation model for use in a decoder are trained. The translation model is then used to re-extract a subset of phrase pairs from the original set of extracted phrase pairs. The feature values associated with the subset of phrase pairs are recalculated, and the translation model parameters are re-trained based on the newly extracted subset of phrase pairs and the features values associated with those phrase pairs.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one machine translation training system.

FIG. 2 is a flow diagram illustrating the overall operation of the system shown in FIG. 1.

FIG. 3A shows one example of a word-aligned corpus.

FIG. 3B shows one example of initially extracted phrase pairs.

FIG. 4 is a flow diagram illustrating the overall operation of the phrase pair re-extraction component shown in FIG. 1.

FIG. 5 is a flow diagram illustrating one illustrative embodiment of a more detailed operation of the phrase pair re-extraction component shown in FIG. 1.

FIG. 6 illustrates a reduction in entries in a phrase translation table using global competitive linking.

FIG. 7 is a flow diagram illustrating a more detailed operation of the phrase pair re-extraction component shown in FIG. 1.

FIG. 8 shows a reduction in the phrase translation table using local competitive linking.

### DETAILED DESCRIPTION

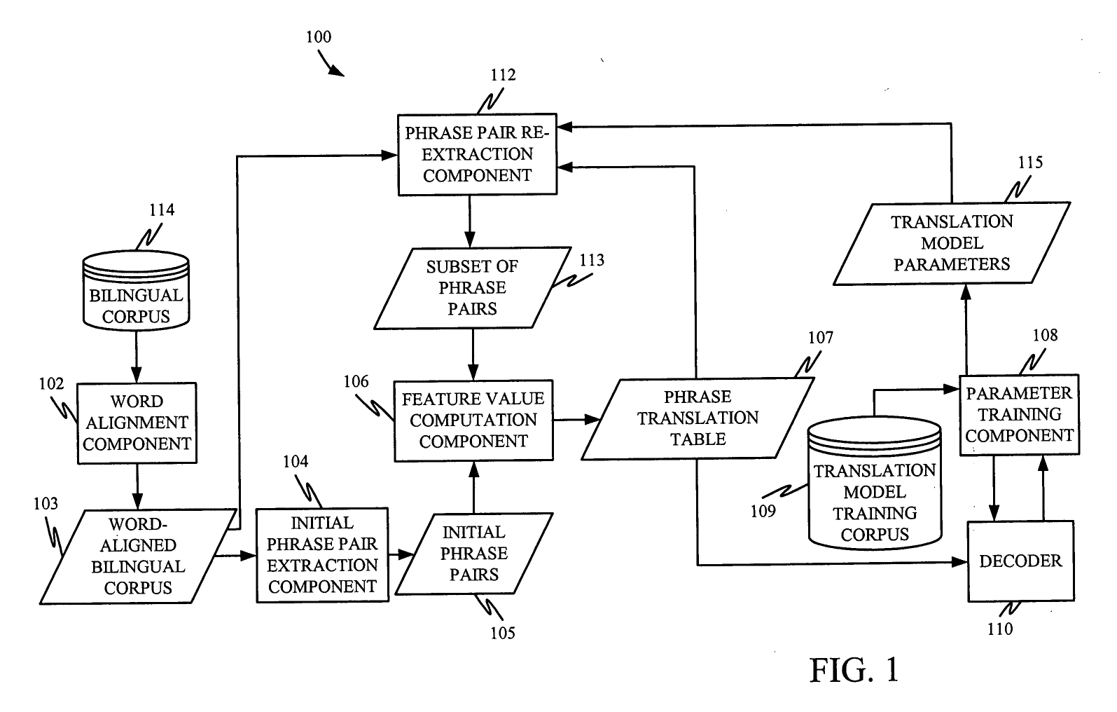

FIG. 1 is a block diagram of a machine translation training system 100 in accordance with one embodiment. System 100 includes word alignment component 102, initial phrase pair extraction component 104, feature value computation component 106, translation model parameter training component 108, translation model training corpus 109, decoder 110 and phrase pair re-extraction component 112. FIG. 1 also shows that system 100 has access to bilingual corpus 114. Bilingual corpus 114 illustratively includes aligned sentences. The aligned sentences are pairs of sentences, each pair of sentences having one sentence that is in the source language and a translation of that sentence that is in the target language.

System 100 trains a translation model for use in decoder 110 such that it translates input sentences by selecting an output that maximizes the score of a weighted linear model, such as that set out below:

$$t = arg {max}_{t , a} {\sum }_{i = 1}^{n} {λ}_{i} {f}_{i} ( s , a , t ) \qquad Eq . 1$$

where s is the input (source) sentence, t is the output (target) sentence, and a is a phrasal alignment that specifies how t is constructed from s. Weight parameters λᵢ are associated with each feature fᵢ, and the weight parameters are tuned to maximize the quality of the translation hypothesis selected by the decoding procedure that computes t set out in Eq. 1.

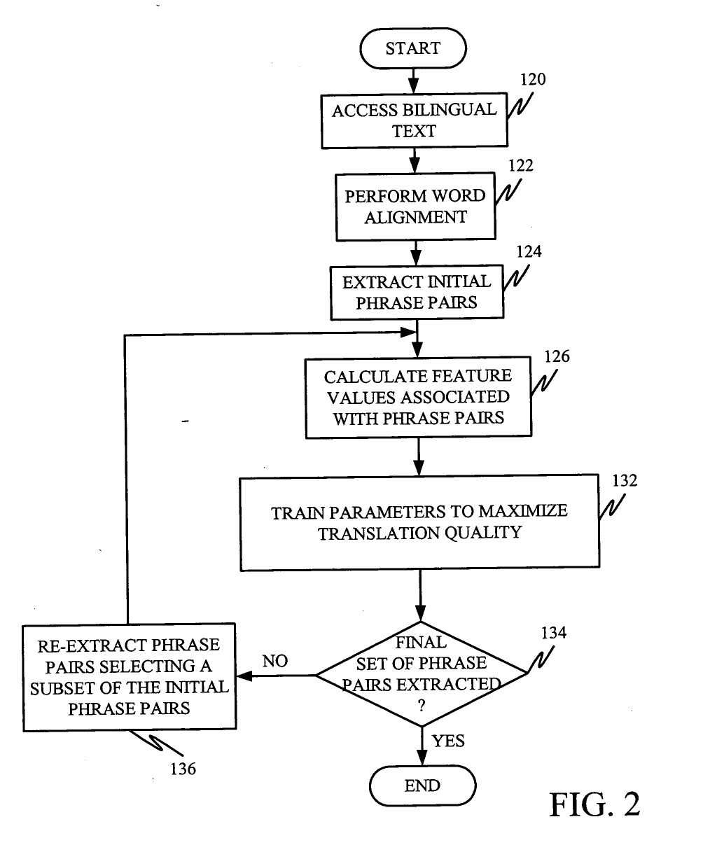

FIG. 2 is a flow diagram illustrating the overall operation of one embodiment of system 100. Word alignment component 102 first accesses the sentence pairs in bilingual training corpus 114 and computes a word alignment for each sentence pair in the training corpus 114. This is indicated by blocks 120 and 122 in FIG. 2. The word alignment is a relation between the words in the two sentences in a sentence pair. In one illustrative embodiment, word alignment component 102 is a discriminatively trained word alignment component that generates word aligned bilingual corpus 103.

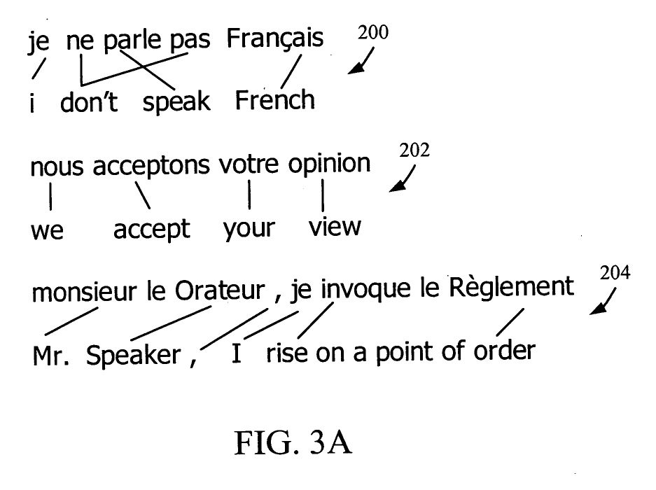

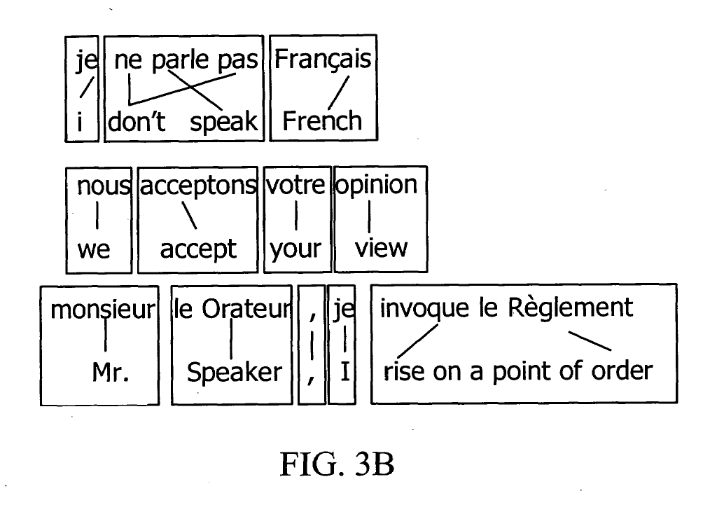

FIG. 3A illustrates three different sentence pairs 200, 202 and 204. In the example shown, the sentence pairs include one French sentence and one English sentence, and the lines between the words in the French and English sentences are the word alignments calculated by word alignment component 102.

Once a word-aligned, bilingual corpus is generated, initial phrase pair extraction component 104 extracts an initial set of phrase pairs from the word-aligned, bilingual corpus for inclusion in the phrase translation table. Extracting the initial phrase pairs is indicated by block 124 in FIG. 2. In one embodiment, every phrase pair is extracted, up to a given phrase length, that is consistent with the word alignment that is annotated in the corpus. In one embodiment, each consistent phrase pair has at least one word alignment between words within the phrases, and no words in either phrase (source or target) are aligned with any words outside of the phrases. FIG. 3B shows some of the phrases that are extracted for the word aligned sentence pairs shown in FIG. 3A. The phrases in FIG. 3B are exemplary only. This initial set of phrase pairs is indicated by block 105 in FIG. 1.

Table 1 shows an example of a more full list of initial phrase pairs 105 consistent with the word alignment of sentence pair 204 in FIG. 3A. It can be seen from Table 1 that a full list using phrases up to three words in length includes 28 pairs. Only the first five and last six are shown in Table 1, for the sake of example.

TABLE 1

| # | Source Lang. Phrase | Target Lang. Phrase |
|---|---|---|
| 1 | Monsieur | Mr. |
| 2 | Monsieur le | Mr. |
| 3 | Monsieur le Orateur | Mr. Speaker |
| 4 | le Orateur | Speaker |
| 5 | Orateur | Speaker |
| . . . | . . . | . . . |
| 23 | le Règlement | point of order |
| 24 | le Règlement | of order |
| 25 | le Règlement | order |
| 26 | Règlement | point of order |
| 27 | Règlement | of order |
| 28 | Règlement | order |

In any case, for each extracted phrase pair (s,t) (where s is the source portion of the phrase pair and t is the target portion of the phrase pair) feature value computation component 106 calculates values of features associated with the phrase pairs. Calculation of the feature values is indicated by block 126 in FIG. 2.

The particular features for which values are calculated can be any of a wide variety of different features. Those discussed herein are for exemplary purposes only, and are not intended to limit the invention.

In any case, one translation feature is referred to as the phrase translation probability. It sums the logarithms of estimated conditional probabilities p(s|t) of each source language phrase s given the corresponding target language phrase t. An analogous feature sums the logarithms of estimated conditional probabilities p(t|s). In one embodiment, estimating the probabilities p(s|t) is performed in terms of relative frequencies as follows:

$$p \text{(} s \vert t ) = \frac{count ( s , t )}{{\sum }_{{s}^{′}} count ( {s}^{′} , t )} \qquad Eq . 2$$

where count(s,t) is the number of time the phrase pairs with the source language phrase s and the target language phrase t was selected from any aligned sentence pair for inclusion in the phrase translation table; and

$${\sum }_{{s}^{′}} count ( {s}^{′} , t )$$

is the number of times phrase pairs with any source language phrase and the same target language phrase t were selected from any aligned sentence pair.

Another feature is referred to as a lexical score feature and provides a simple form of smoothing by weighting a phrase pair based on how likely individual words within the phrases are to be translations of each other. According to one embodiment, this is calculated as follows:

$$l ( s , t ) = \frac{1}{m} {\prod }_{i = 1}^{n} {\sum }_{j = 1}^{m} p ( {s}_{i} \vert {t}_{j} ) \qquad Eq . 3$$

where n is the number of words in s, m is the number of words in t, and the p(sᵢ|tⱼ) are estimated word translation probabilities.

Decoder 110, in performing statistical machine translation, produces translation by dividing the source sentence into a sequence of phrases, choosing a target language phrase as a translation for each source language phrase, and ordering the chosen target language phrases to build the final translated sentence. Each potential translation is scored according to a weighted linear model, such as that set out in Eq. 1 above. In one embodiment, the decoder uses the three features discussed above, along with four additional features.

Those four additional features can include a target language model which is the logarithm of the probability of the full target language sentence, p(t), estimated using a tri-gram language model. A second feature is a distortion penalty that discourages reordering of the words. The penalty is illustratively proportional to the total number of words between the source language phrases corresponding to adjacent target language phrases. Another feature is a target sentence word count which is simply the total number of words in the full sentence translation. A final feature is the phrase pair count which is the number of phrase pairs that were used to build the full sentence translation.

Parameter training component 108 accesses training data in translation model training corpus 109 and estimates the parameters λᵢ (indicated by 115 in FIG. 1) of the weighted linear model shown in Eq. 1. Corpus 109 is illustratively a bilingual corpus that may (but need not) be word aligned. It can also be part of, or distinct from, bilingual corpus 114, but it is believed that superior results will be obtained if corpus 109 is distinct from corpus 114. It may also illustratively be configured to have multiple target language translation for each source sentence, but that is optional. In one illustrative embodiment, a minimum error rate training mechanism is used by which decoder 110 is repeatedly run to create n-best lists of possible translations that are repeatedly re-ranked by changing the parameter values (λᵢ) to maximize translation quality according to a predetermined metric. One illustrative metric is referred to as the BLEU score. Training parameters 115 to maximize translation quality is indicated by block 132 in FIG. 2.

After the initial phrase translation table 107 is generated and the translation model for use in decoder 110 is initially trained, phrase pair re-extraction component 112 determines whether the phrase translation table 107 contains the final set of extracted phrase pairs, or whether it only contains the initial set of extracted phrase pairs. This is indicated by block 134 in FIG. 2. If the final set of phrase pairs has been extracted, then the process is complete.

However, if only the initial set of phrase pairs has been extracted in the phrase translation table 107, then component 112 re-extracts phrase pairs, selecting a subset of the initial set of phrase pairs in the phrase translation table 107. This is indicated by block 136 in FIG. 2. Processing then reverts back to block 126 where the feature values associated with the subset of phrase pairs are recalculated, along with the parameter values in block 132.

It will be noted that it is important to select high quality phrase pairs for the phrase translation table 107. Since phrase translation probabilities are estimated based on counting phrase pairs extracted from the word alignments, the quality of the estimates depends on the quality of the extracted pairs. If bad phrase pairs are included in the phrase translation table 107, not only do they provide more possible ways of producing bad translations, but they add noise to the translation probability estimates for the phrases they contain from their use in the denominator of the estimation formula set out in Eq. 2 above.

Therefore, in extracting the subset of phrase pairs, phrase pair re-extraction component 112 attempts to extract that subset of phrase pairs (indicated by block 113 in FIG. 1) based, at least in part, on a function that returns a high score for pairs that lead to high quality translations. Component 112 also extracts the subset of phrase pairs by imposing redundancy constraints that attempt to minimize the number of possible translations that are extracted for each phrase occurrence.

Scoring the phrase pairs is performed using a metric that may desirably yield high scores for phrase pairs that lead to high quality translations and low scores to those that decrease translation quality. One such metric is provided by the overall translation model in decoder 110. The scoring metric, q(s,t), is therefore computed by first extracting a full phrase translation table, then training a full translation model (for decoder 110) as discussed above with respect to FIG. 2, and then using a subpart of the model trained for decoder 110 to score individual phrase pairs, in isolation. It will be noted (at block 132 in FIG. 2) the translation model for decoder 110 has already been optimized to maximize translation quality. Thus, scoring the phrases 105 initially extracted and placed in the phrase translation table, using the optimized translation model, provides scores for those phrases, where the higher scores are given to more desirable phrase pairs.

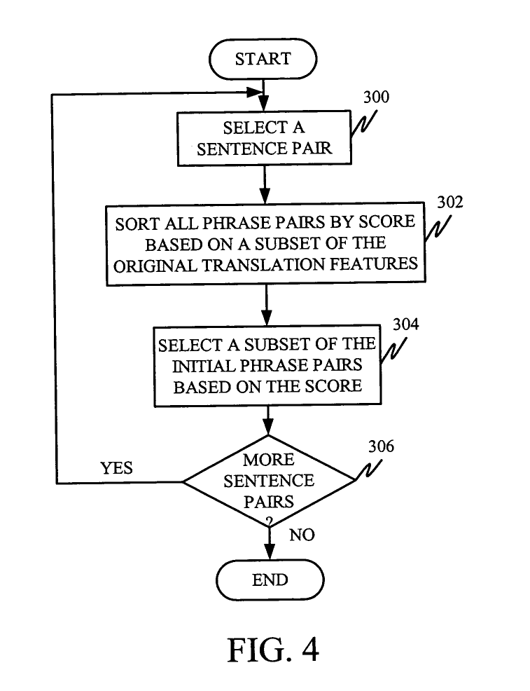

FIG. 4 is a flow diagram better illustrating how to re-extract phrase pairs (as set out in block 136 in FIG. 2) using a portion of the model in decoder 110. First, re-extraction component 112 selects a sentence pair for which the initial phrases have already been extracted. This is indicated by block 300 in FIG. 4. Next, re-extraction component 112 uses a portion of the translation model trained for decoder 110 to score each of the initial phrase pairs in the phrase translation table 107, and then sorts all the phrase pairs (for the sentence pair selected at block 300) based on their scores. This is indicated by block 302 in FIG. 4.

More specifically, in one embodiment, the scoring metric is computed as follows:

q(s,t)=φ(s,t)·λ Eq. 4

where φ(s,t) is a length three vector that contains the feature values stored with the pair (s,t) in the initial phrase translation table 107. In other words, the logarithms of the conditional translation probabilities p(s|t) and p(t|s) and the lexical score l(s,t) are the three feature values in the vector. Also, λ is a vector of the three weight parameters that were learned for these features in the full translation model used by decoder 110. They are combined in Eq. 4 by the vector dot product operation, which sums the product of the value and the weight for each of the features.

The rest of the features discussed above used in initially calculating the translation model for decoder 110 are, in one illustrative embodiment, not used because they are either constant or because they depend on the target language sentence which is fixed during phrase extraction. Basically, in the present embodiment being discussed, the subpart of the full translation model for decoder 110 that is used to score phrase pairs during re-extraction is that part of the translation model that actually considers phrase pair identity, and applies a score based on how much the full model would prefer this phrase pair.

Once the initially extracted phrase pairs 105 are scored by the portion of the full translation model for decoder 110 that utilizes these features, a subset of the original phrase pairs is then selected based upon the scores calculated. This is indicated by block 304 in FIG. 4. Re-extraction component 112 performs the steps of selecting a sentence pair, sorting all the phrase pairs in order of a score derived from the subset of the original translation features, and selecting a subset of the initial phrase pairs based on their scores, for all of the phrase pairs identified for each sentence pair in the training data. Therefore, if there are more sentence pairs to be considered, processing reverts back to block 300. If not, then the full subset of phrase pairs has been identified. This is indicated by block 306 in FIG. 4.

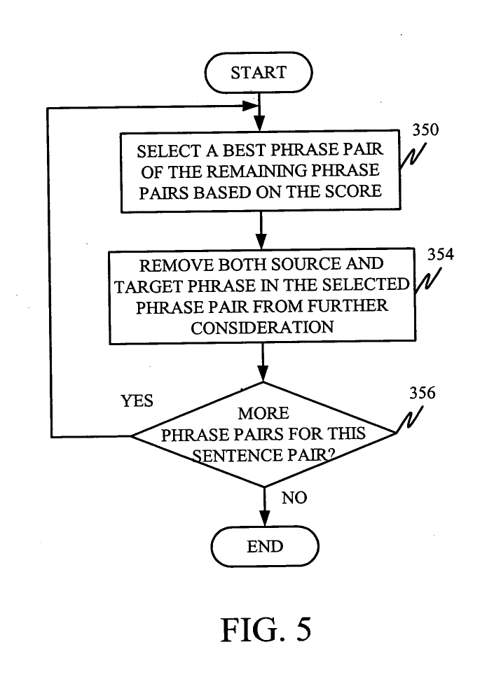

There are a variety of different ways to select the subset of phrase pairs based on their scores, as indicated by block 304. FIG. 5 is a flow diagram illustrating one embodiment of the operation of phrase pair re-extraction component 112, in extracting the subset of the initial phrase pairs using the scores calculated in block 302 in FIG. 4. The mechanism by which the subset of phrase pairs is identified in FIG. 5 is referred to as global competitive linking. The global competitive linking mechanism attempts to extract as many high scoring phrase pairs as possible from each sentence pair, while enforcing the constraint that no two phrase pairs extracted from the same sentence pair share a source language phrase or a target language phrase.

Therefore, assuming that all of the phrase pairs for the given sentence pair are sorted by score, re-extraction component 112 selects the best scoring phrase pair based upon the score calculated. This is indicated by block 350 in FIG. 5.

Re-extraction component 112 then removes both the source and target language phrases in the selected phrase pair from further consideration. This is indicated by block 354 in FIG. 5. Re-extraction component 112 then determines whether any more phrase pairs remain to be considered for this sentence pair. If so, processing continues at block 350 where the next best scoring phrase pair is selected and all phrase pairs involving the source and target language phrases for that phrase pair are removed from further consideration. This continues until either no phrase pairs are remaining, or until a desired number of phrase pairs have been selected. Repeating the process of identifying more phrase pairs is indicated by block 356 in FIG. 5.

By way of example, consider the phrase pairs in Table 1 above and assume that these phrase pairs have already been sorted by score q(s,t). The global competitive linking mechanism set out in FIG. 5 selects phrase pairs 1, 3, 4, 23 and 27. The other phrase pairs are eliminated because a higher scoring phrase pair shares a phrase with them. For example, the inclusion of phrase pair 1 stops phrase pair 2 from being selected, because the target language phrase “Mr.” has already been used in the first phrase pair (which is higher scoring than the second phrase pair). Therefore, it cannot be considered in subsequent phrase pairs, such as the second phrase pair.

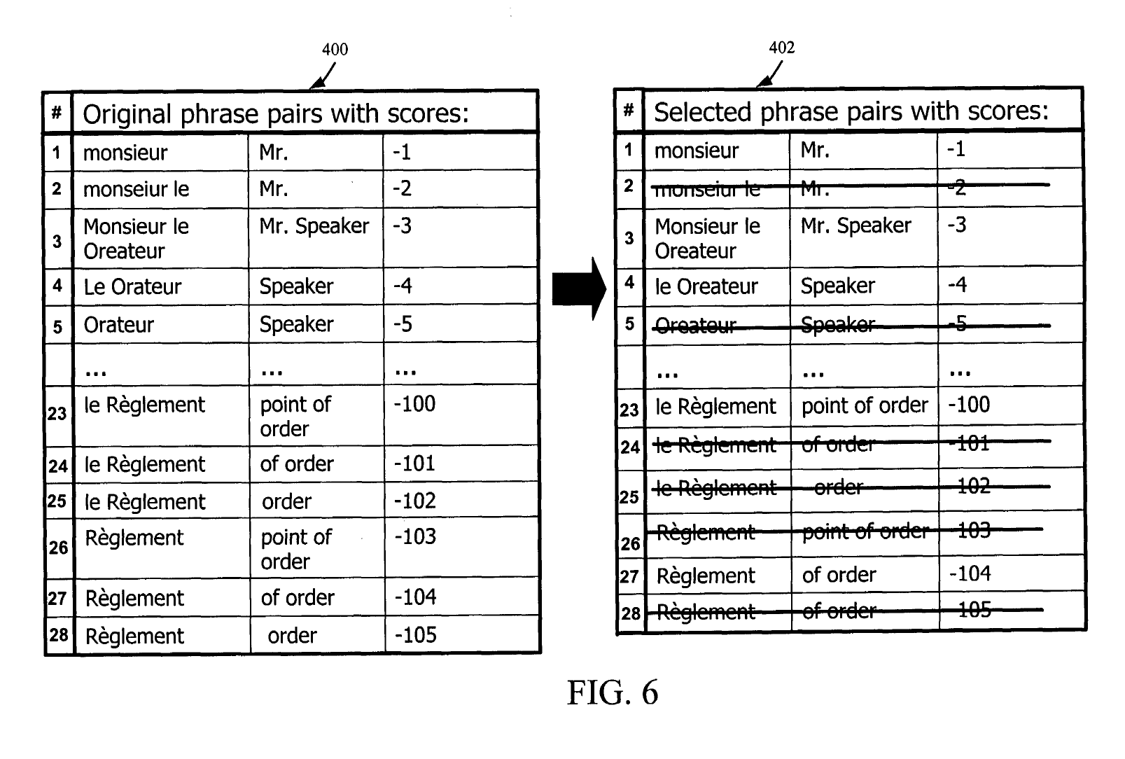

FIG. 6 is a more detailed table illustrating the operation of the global competitive linking mechanism. FIG. 6 shows original phrase pairs, with scores, indicated by numeral 400. It will be noted that the phrase pairs have been sorted based on score. FIG. 6 also shows the subset of selected phrase pairs, extracted by re-extraction component 112, by applying global competitive linking. This is indicated by 402 in FIG. 6. Thus, FIG. 6 illustrates whenever a phrase pair is selected in a particular sentence pair as one of the phrase pairs in the re-extracted subset of phrase pairs, all lower scoring phrase pairs that include either the source or target language phrase from the selected phrase pair are eliminated from consideration in that sentence pair.

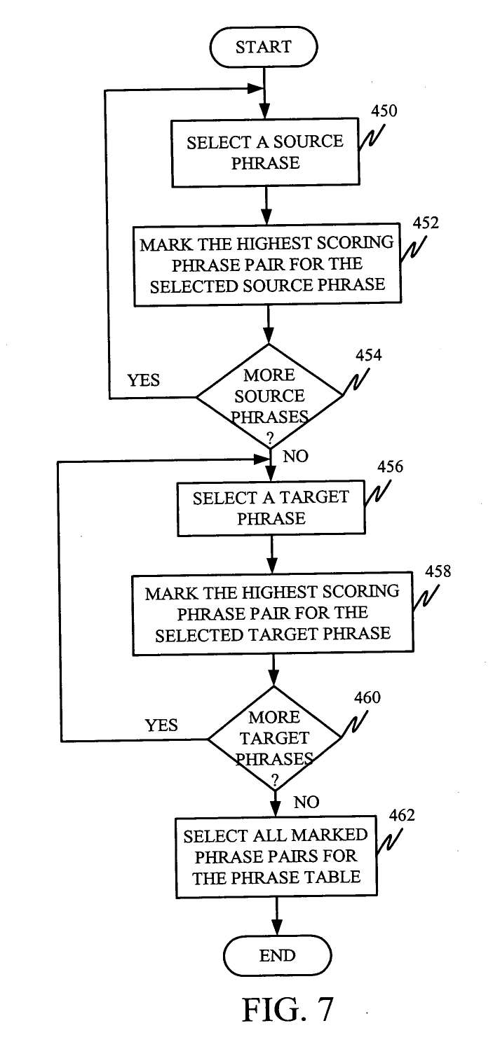

Another mechanism by which re-extraction component 112 can select a subset of the initial phrase pairs based on their score (as indicated by block 304 in FIG. 4) is by using a mechanism referred to as local competitive linking. Local competitive linking also extracts a large number of high scoring phrase pairs, but it enforces a less restrictive redundancy constraint than global competitive linking discussed with respect to FIG. 5 above. FIG. 7 is a flow diagram illustrating a more detailed operation of re-extraction component 112 in extracting the subset of phrase pairs 113 using local competitive linking.

It will be assumed that a sentence pair has been selected and all of the initial phrase pairs 105 identified for that sentence pair have been scored and ordered based on that score, as discussed above. Re-extraction component 112 first selects a source language phrase from the sorted phrase pairs. This is indicated by block 450 in FIG. 7.

Component 112 then marks the highest scoring phrase pair occurring in the sentence pair for the selected source language phrase. This is indicated by block 452. Component 112 repeats this process for each distinct source language phrase in the set of initial phrase pairs 105 occurring in the sentence pair. This is indicated by block 454 in FIG. 7.

Component 112 then selects a target language phrase from the ordered set of phrase pairs. This is indicated by block 456. Component 112 then marks the highest scoring phrase pair occurring in the sentence pair for the selected target language phrase. This is indicated by block 458. Component 112 repeats this process, selecting a target language phrase and marking the highest scoring phrase pair occurring in the sentence pair for the selected target language phrase, for all distinct target language phrases in the initial set of phrase pairs 105 occurring in the sentence pair. This is indicated by block 460 in FIG. 7.

Once the phrase pairs are marked in this way, component 112 selects all of the marked phrase pairs for inclusion in the phrase translation table. These marked phrase pairs taken from all sentence pairs then form the subset of phrase pairs 113 that ultimately end up in the phrase translation table. This is indicated by block 462 in FIG. 7.

It can be seen that the local competitive linking mechanism described with respect to FIG. 7 enforces a softer redundancy constraint than the global competitive linking mechanism discussed with respect to FIG. 5. This is because a phrase pair will only be excluded from those selected from a particular sentence pair in local competitive linking if there is a higher scoring pair occurring in the sentence pair that shares its source language phrase and a higher scoring pair occurring in the sentence pair that shares its target language phrase.

For example, again consider the phrase pairs in Table 1 above. Assume also that they are sorted by their scores. The local competitive linking mechanism set out in FIG. 7 will select every phrase pair except for phrase pairs 27 and 28. All of the other phrase pairs in Table 1 are the highest scoring options for at least one of their source or target language phrases, and therefore, they will be retained in the phrase translation table.

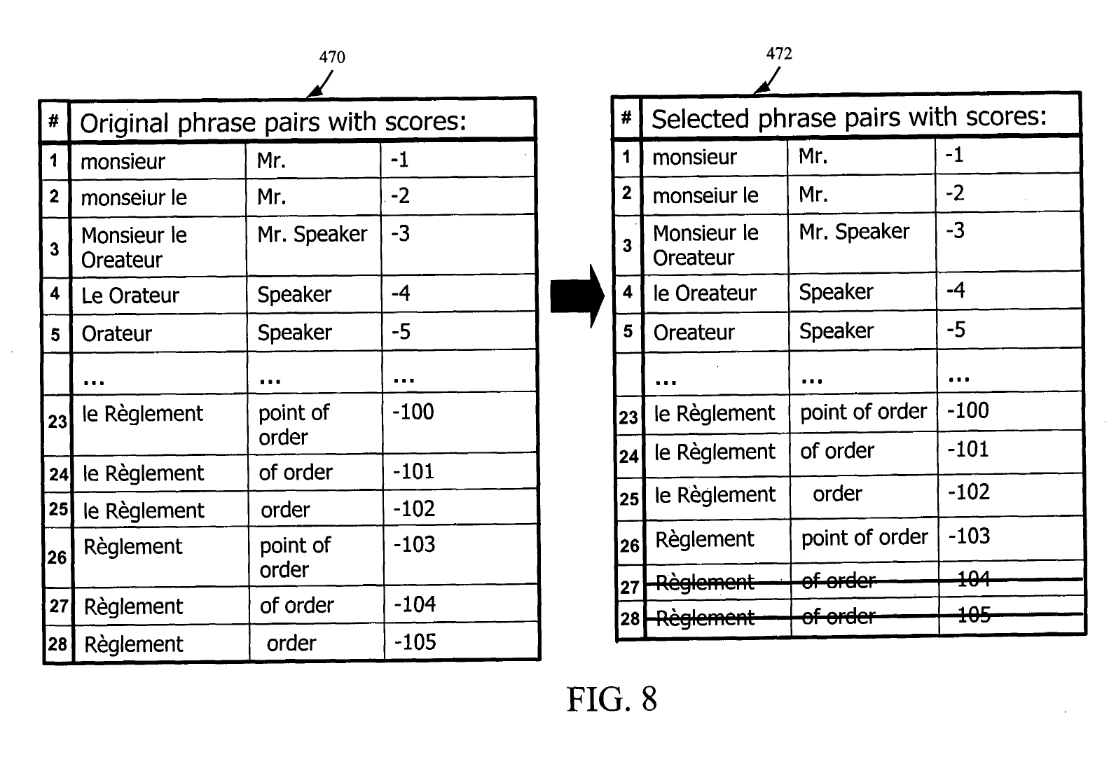

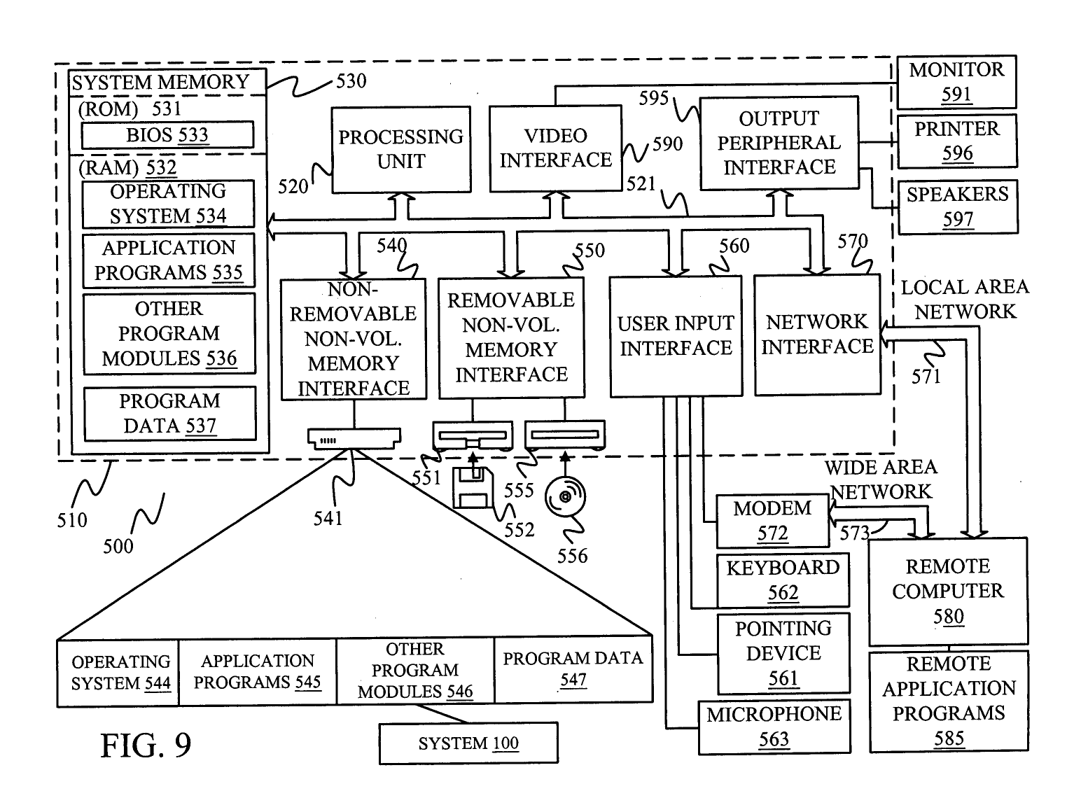

FIG. 8 shows this in more detail. FIG. 8 shows a set of original phrase pairs, with feature scores, sorted by score. This is indicated by block 470 in FIG. 8. FIG. 8 also shows the selected subset of phrase pairs, along with their scores, after component 112 applies the local competitive linking mechanism described above with respect to FIG. 7. This is indicated by block 472.

It can thus be seen that both the global and local competitive linking mechanisms prune the full phrase translation table from what it was initially. It has been observed that both of these mechanisms significantly reduce the size of the phrase translation table. For instance, in one embodiment, it was seen that global competitive linking reduced the size of the phrase translation table to approximately one-third the initial size. Similarly, the local competitive linking mechanism reduced the size of the phrase translation table by approximately 45 percent. While global competitive linking reduced the size of the phrase translation table the most, it resulted in a slight loss of translation quality (as reflected by the BLEU score). Local competitive linking, on the other hand, not only reduced the size of the phrase translation table significantly, but also resulted in an increase in translation quality, as reflected by the BLEU score.

FIG. 9 illustrates an example of a suitable computing system environment 500 on which embodiments may be implemented. The computing system environment 500 is only one example of a suitable computing environment and is not intended to suggest any limitation as to the scope of use or functionality of the claimed subject matter. Neither should the computing environment 500 be interpreted as having any dependency or requirement relating to any one or combination of components illustrated in the exemplary operating environment 500.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 9, an exemplary system for implementing some embodiments includes a general-purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 9 illustrates operating system 534, application programs 535, other program modules 536, and program data 537.

The computer 510 may also include other removable/non-removable volatile/nonvolatile computer storage media. By way of example only, FIG. 9 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 140, and magnetic disk drive 551 and optical disk drive 555 are typically connected to the system bus 521 by a removable memory interface, such as interface 550.

The drives and their associated computer storage media discussed above and illustrated in FIG. 9, provide storage of computer readable instructions, data structures, program modules and other data for the computer 510. In FIG. 9, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. FIG. 9 shows that, in one embodiment, system 100 resides in other program modules 546. Of course, it could reside other places as well, such as in remote computer 580, or elsewhere.

A user may enter commands and information into the computer 510 through input devices such as a keyboard 562, a microphone 563, and a pointing device 561, such as a mouse, trackball or touch pad. Other input devices (not shown) may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 is operated in a networked environment using logical connections to one or more remote computers, such as a remote computer 580. The remote computer 580 may be a personal computer, a hand-held device, a server, a router, a network PC, a peer device or other common network node, and typically includes many or all of the elements described above relative to the computer 510. The logical connections depicted in FIG. 9 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 9 illustrates remote application programs 585 as residing on remote computer 580. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of training a phrase-based machine translation system, comprising:
extracting an initial set of phrase pairs from a word aligned bilingual training corpus, each of the phrase pairs having a source language phrase in a first language and a target language phrase in a second language;
extracting features, having initial feature values, from the initial set of phrase pairs;
training translation model parameters for a decoder based on the initial set of phrase pairs and the feature values;
extracting a subset of the initial set of phrase pairs using the trained translation model parameters; and
saving the subset for use with the decoder in a machine translation system.

2. The method of claim 1 wherein the word aligned bilingual corpus has aligned sentence pairs, and wherein extracting an initial set of phrase pairs comprises:
extracting an initial set of phrase pairs for each aligned sentence pair based on a word alignment of words in the aligned sentence pair.

3. The method of claim 2 and further comprising:
re-estimating the feature values based on the extracted subset of phrase pairs, for use in the decoder.

4. The method of claim 3 and further comprising:
re-training the translation model parameters based on the extracted subset of phrase pairs and the re-estimated feature values.

5. The method of claim 4 wherein extracting a subset of phrase pairs comprises:
scoring each of the initial set of phrase pairs occurring in an aligned sentence pair with a portion of the trained translation model;
sorting the initial set of phrase pairs occurring in the aligned sentence pair by the score; and
selecting one or more phrase pairs occurring in the aligned sentence pair to include in the subset of phrase pairs based on the score.

6. The method of claim 5 wherein extracting a subset of phrase pairs further comprises:
repeating the steps of scoring, sorting and selecting for the initial set of phrase pairs extracted for each aligned sentence pair, independently of the initial set of phrase pairs extracted for other aligned sentence pairs.

7. The method of claim 5 wherein selecting phrase pairs to include in the subset of phrase pairs comprises:
selecting a source language phrase in the sorted initial set of phrase pairs;
marking a highest scoring phrase pair with the selected source language phrase occurring in the aligned sentence pair;
repeating the steps of selecting a source language phrase and marking a highest scoring phrase pair, for a plurality of different source language phrases.

8. The method of claim 7 wherein selecting a subset of phrase pairs further comprises:
selecting a target language phrase in the sorted initial set of phrase pairs;
marking a highest scoring phrase pair with the selected target language phrase occurring in the aligned sentence pair;
repeating the steps of selecting a target language phrase and marking a highest scoring phrase pair, for a plurality of different target language phrases.

9. The method of claim 8 wherein selecting a subset of phrase pairs further comprises:
selecting the marked phrase pairs to include in the subset of phrase pairs.

10. The method of claim 9 and further comprising:
repeating the steps of:
selecting a source language phrase and marking a highest scoring phrase pair for a plurality of different source language phrases; selecting a target language phrase and marking a highest scoring phrase pair for a plurality of different target language phrases; and
selecting the marked phrase pairs, for the phrase pairs in the initial set of phrase pairs extracted for each aligned sentence pair, independently of the initial set of phrase pairs extracted for other aligned sentence pairs.

11. The method of claim 5 wherein selecting one or more phrase pairs occurring in the aligned sentence pair comprises:
selecting a highest scoring phrase pair, from the initial set of phrase pairs occurring in the aligned sentence pair;
removing all phrase pairs having a same source language phrase or a same target language phrase, as the selected phrase pair, from the sorted initial set of phrase pairs occurring in the aligned sentence pair; and
repeating the steps of selecting a highest scoring phrase pair, adding and removing, for all remaining phrase pairs in the initial set of phrase pairs occurring in the aligned sentence pair.

12. A system for generating a phrase translation table for use in a machine translation system, comprising:
an initial phrase pair extraction component configured to extract an initial set of phrase pairs from a word aligned bilingual corpus;
a feature extraction component configured to extract features and calculate feature values for a set of features based on the extracted initial set of phrase pairs;
a training component configured to train parameters in a translation model; and
a re-extraction component configured to extract a subset of phrase pairs from the initial set of phrase pairs based on a subset of features used in the translation model and to store the subset of phrase pairs in the phrase translation table, along with feature values calculated for each of the phrase pairs in the subset.

13. The system of claim 12 wherein the feature extraction component is configured to recalculate the feature values based on the subset of phrase pairs.

14. The system of claim 13 wherein the re-extraction component is configured to store the subset of phrase pairs in the phrase translation table along with the recalculated feature values.

15. The system of claim 13 wherein the training component is configured to retrain the parameters in the translation model based on the subset of phrase pairs and recalculated feature values.

16. The system of claim 12 wherein the re-extraction component is configured to extract the subset of phrase pairs by scoring the phrase pairs in the initial set of phrase pairs using the subset of features and selecting the subset of phrase pairs based on the score.

17. The system of claim 16 wherein the re-extraction component is configured to extract the subset of phrase pairs using a competitive selection based on the score.

18. A computer readable medium storing computer readable instructions which, when executed, cause a computer to perform a phrase translation table generation method, comprising:
extracting a first set of phrase pairs from a word aligned bilingual corpus;
training a machine translation model, configured to receive an input in a source language and to translate it into an output in a target language, based on the first set of phrase pairs;
using a portion of the machine translation model to extract a second set of phrase pairs, the second set of phrase pairs being a subset of the first set of phrase pairs, for inclusion in the phrase translation table; and
re-training the machine translation model based on the second set of phrase pairs.

19. The computer readable medium of claim 18 wherein re-training comprises:
re-training weight parameters applied to feature values in the machine translation model.

20. The computer readable medium of claim 18 wherein using a portion of the machine translation model to extract the second set of phrase pairs comprises:
scoring the first set of phrase pairs with the portion of the machine translation model; and
competitively selecting the second set of phrases based on the score.
